(19) United States
(12) Patent Application Publication
(10) Pub. No.: US 2011/0208664 A1
(43) Pub. Date: Aug. 25, 2011

(54) Employment portal enabling interactive mobile contact and feedback

(76) Inventor: Nadimur Rahman, Brossard (CA)

(21) Appl. No.: 12/656,995

(22) Filed: Feb. 23, 2010

(51) Int. Cl. G06Q 10/00; G06Q 99/00; G06Q 30/00; G06F 3/01

(52) U.S. Cl. 705/321; 705/347; 715/758

(57) ABSTRACT

The present invention relates to an enabled real time interaction between an employer and a job seeker. The job seeker submits resume information on a job portal and may enable a chat session option should an employer request one. The job seeker may download a chat client on his or her computer as well as a wireless mobile device. An employer that wants to contact a matched job seeker sends a chat request that activates the downloaded chat client on a computer or a mobile device of the job seeker without the job seeker logged on the website. The employer may be enabled to chat via a similar downloaded chat software module as the job seeker. The job seeker may be provided with job related feedback statistics before or after the application is made.

### FIELD OF THE INVENTION

The present invention is related to an internet based employment portal having real time interactive capability between a job seeker and a prospective employer and job related feedback from the portal to the job seeker.

### BACKGROUND OF THE INVENTION

Web based employment portals facilitate employers and job applicants by creating a store of applicant information submitted by applicants with access by employers to select and process relevant candidates. Once selected, the prospective applicant may be contacted by a number of means including phone, email and traditional posts. An attempt to contact the candidate the first time by phone may not be successful unless the client can expect a call at a certain time or the client just answers the phone. Similarly, an email sent may be replied to later. In order to reduce the chances of a first time contact being received and responded without a lag, a communication capability enabling real time response is needed that can also potentially prepare the job seeker to expect a contact with an employer right at the at the time of resume submission.

One example of a real time interactive recruitment is that given by US patent application with publication number 20030125970. Here the invention provides for real time online interactive recruitment, whereby a recruiter is able to contact a job seeker in real time when the job seeker is most interested in a job. The recruiter who can be company recruiter can further employ web enabled chat session (on a PC or mobile) to discuss with the job seeker his or her preferences to ascertain the candidacy of the job seeker. However, a restriction is there that the job seeker be logged onto a website where his or her resume information is being submitted. Any action of the job seeker on the website triggers a recruiter administrator to compile a relevant job search and contact an available recruiter. Only then an available recruiter can interact with a job seeker whose is currently on the website having the resume information. The present invention overcomes this kind of two way online availability of the job provider or recruiter and job seeker.

An application process through a portal can become more meaningful when the applicant is able to see some details of the competing candidates. The present invention provides a way for the applicant to assess the competition at hand.

### SUMMARY

The present invention is a computer network implemented method, a system and a computer program product to enable real time interaction between an employer and a job seeker. The job seeker submits his or her resume information on an employment portal and may further preauthorize a chat session option should a prospective employer request one. As such the job seeker may download a chat software module on his or her computer as well as a wireless mobile device. An employer posts a job on the employment portal website where a website agent processes limited number of best matches for the posted job from the database of applicant resumes. When an employer or a recruiter, while reviewing applicant resumes for the posted job on the employment portal, wants to contact a matched job seeker he or she may send a chat request that activates on the downloaded chat software module on a computer or a mobile device of the job seeker without the job seeker logged on the job portal website. The employer or recruiter may also be enabled to chat via a similar downloaded chat client as the job seeker. The jobseeker, while applying for a job may be provided with job related feedback statistics before or after the application is made.

One aspect of the present invention is a computer implemented method for enabling real time interaction for recruitment between a job seeker and a job provider via an internet based employment portal, the method comprising; said job provider posting a job on the employment portal; said job seeker applying for a posted job on the employment portal and enabling a chat functionality by checking a check box and downloading a chat client; said job seeker further checking a check box to access a feedback of job related statistics; said job seeker being provided with the feedback of job related statistics for the posted job; the job provider sending a request for a chat session with the job seeker; and the job provider interacting real time with the job seeker with a downloaded chat client.

Another aspect of the present invention is a system for enabling real time interaction for recruitment between a job seeker and a job provider via an internet based employment portal, via a computer network, comprising: a first data receiving component, adapted to receive computer readable data, representing information pertaining to a job, is provided by a job provider via said computer network; the data receiving component, adapted to receive computer readable data, representing information pertaining to a job seeker is provided by the job seeker via said computer network, the information in part comprised of an enabled chat functionality a first checked off check box as well as a second checked off check box to enable job seeker access to a feedback of job related statistics; a chat client downloaded by the job seeker to a computer as well as a mobile device; the data receiving component, adapted to receive computer readable data, representing information pertaining to a request from the job provider for a chat session with the job seeker; and an activated chat client at a second computing device enabling real time interaction between the job provider and the jobseeker.

These and other aspects will be apparent to those of ordinary skill in the art.

### BRIEF DESCRIPTION OF THE DRAWINGS

The invention will be better understood with reference to the drawings, in which:

FIG. 1 is a flow-chart diagram illustrating the major steps in a process through which a job seeker applies for a job and gets contacted by a job provider

FIG. 2 illustrates the main landing page of the job portal.

FIG. 3 illustrates a portion of the job seeker section of the job portal.

FIG. 4 illustrates a portion of the job seeker section of the job portal.

FIG. 5 illustrates a portion of the job seeker section of the job portal.

FIG. 6 illustrates a portion of the job provider section of the job portal.

FIG. 7 illustrates a portion of the job provider section of the job portal.

FIG. 8 illustrates a portion of the job provider section of the job portal.

FIG. 9 illustrates a portion of the job provider section of the job portal.

FIG. 10 illustrates a sample of the job related feedback made available to the job seeker.

### DETAILED DESCRIPTION OF THE INVENTION

### Overview

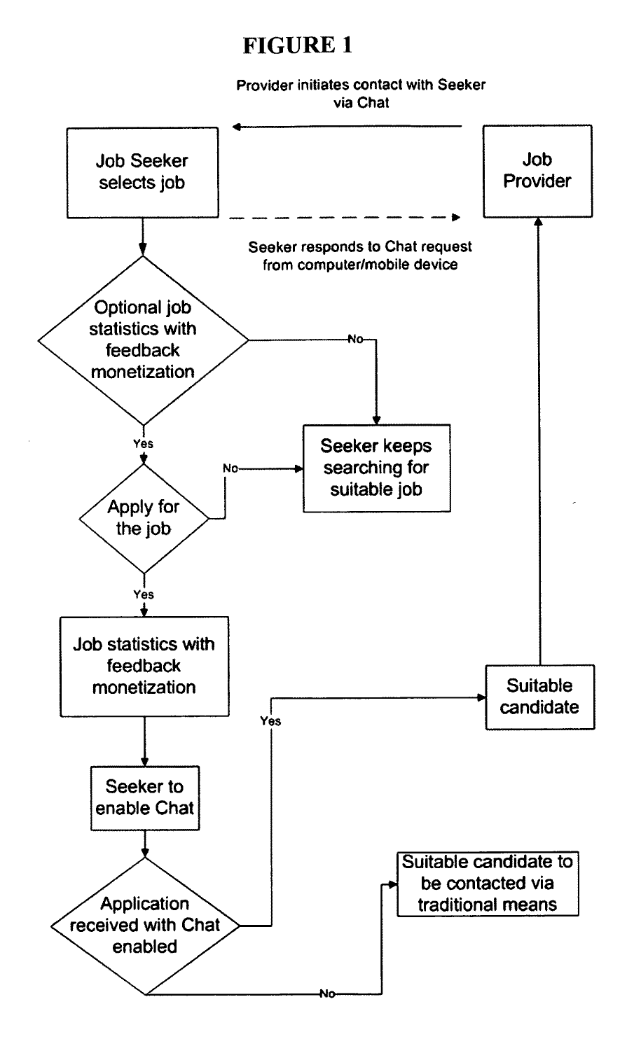

The present invention is a computer network implemented method, a system and a computer program, product to enable real time interaction between an employer or a recruiter and a job seeker depicted by FIG. 1. The job seeker submits his or her resume information on an employment portal. The job seeker can further preauthorize a chat session option should a prospective employer request one. In order to enable receiving a chat request and chat, the job seeker downloads a chat software module on his or her computer as well as a wireless mobile device. An employer or a recruiter posts a job on the employment portal website where a website agent processes limited number of best matches for the posted job from the database of applicant resumes. When an employer or a recruiter, while reviewing resumes for the posted job on the employment portal, wants to contact a matched job seeker that has opted for chat enablement, he or she sends a chat request that activates on the downloaded chat software module on a computer or a mobile device of the job seeker without the job seeker on the website. The employer or recruiter is enabled to chat via a similar downloaded chat software module as the job seeker. The jobseeker, while applying for a job may be provided with job related statistics before or after the application is made.

Website for Connecting Job seeker and Employer

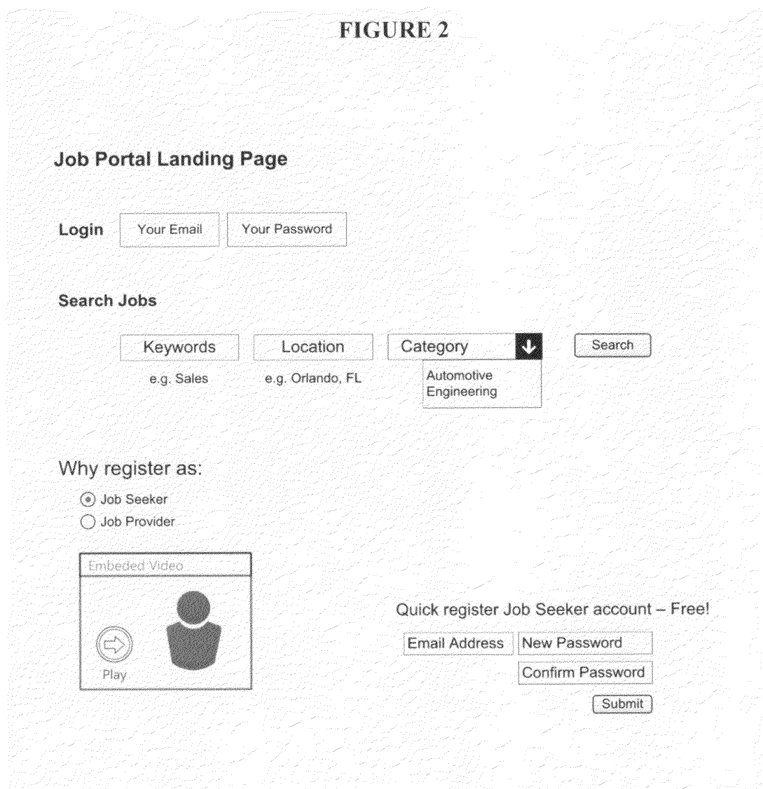

FIG. 1 and FIG. 2 describe a website which is an employment portal that receives job posts from employers as well as resume and profile information from job seekers. The website has at least three sections, a home page, a job seeker section and job provider section. The home page, as given by FIG. 2, provides an overview of the employment portal. The portal home page may provide an option for a job seeker or job provider to register with the portal. In addition, the home page may further provide a link to a video that shows advantages of registering at the portal for a job seeker or job provider. The option of registering, as a job seeker or job provider, along with the video may be available on the home page via selection of a menu indicating either a “Job Seeker” status or “ Job Provider” status.

In addition, the home page provides a search window for registered or unregistered job seekers to search for jobs. The home page also enables a job seeker to view the search results of the job search. The search results are displayed on a search landing page. The search landing page, not shown, may further have an inset video targeting job seekers why should they register on the employment portal. A link to “Register” may also be provided as well. Once a job provider or a job seeker registers with the portal they can login from the home page of the portal.

### Job Seeker Section

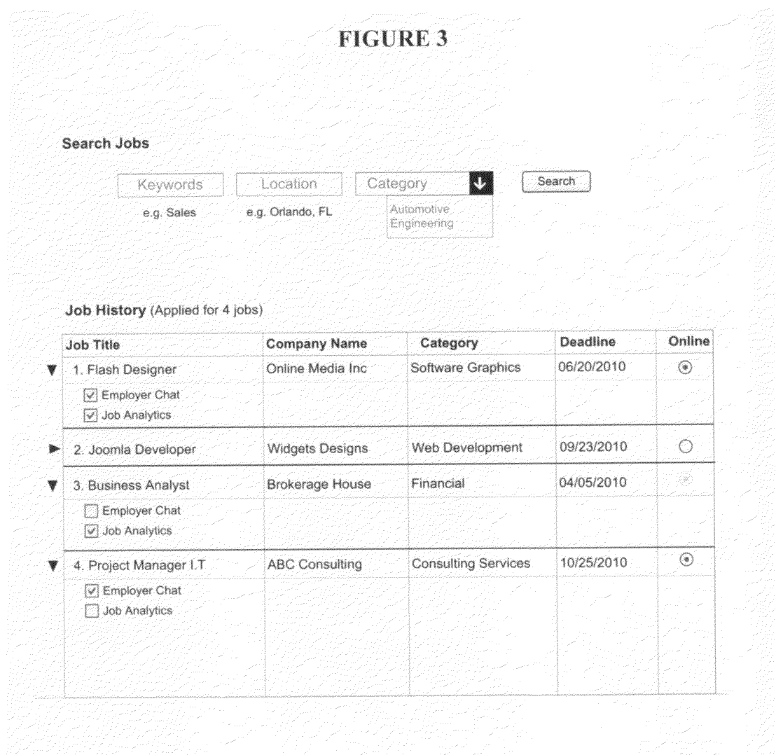

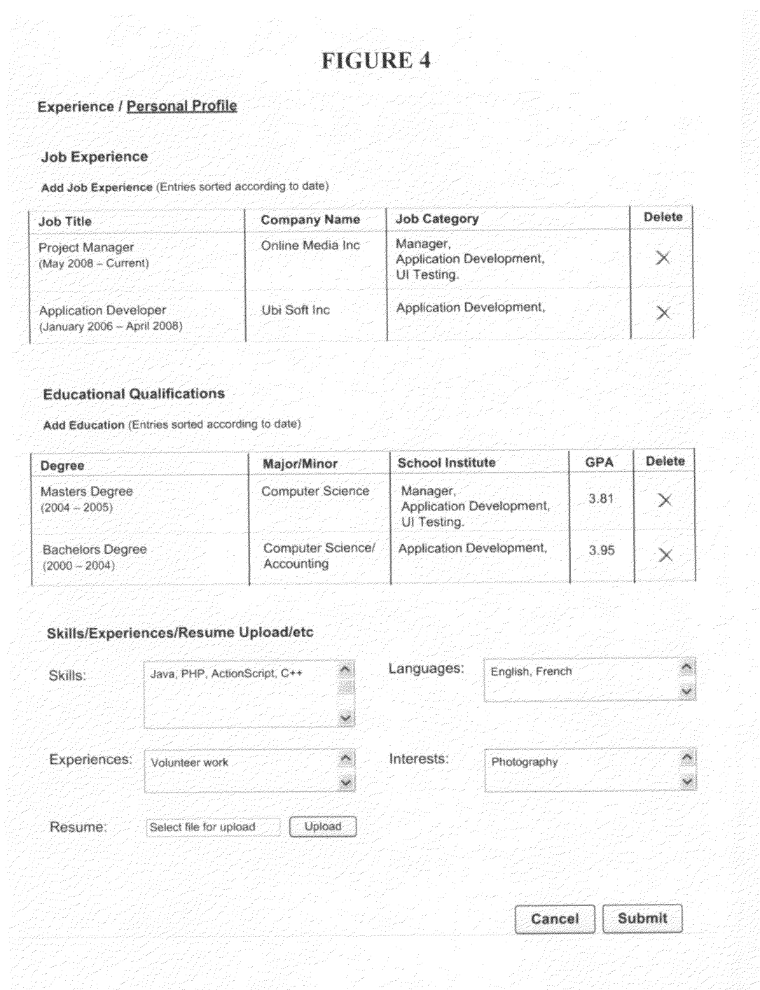

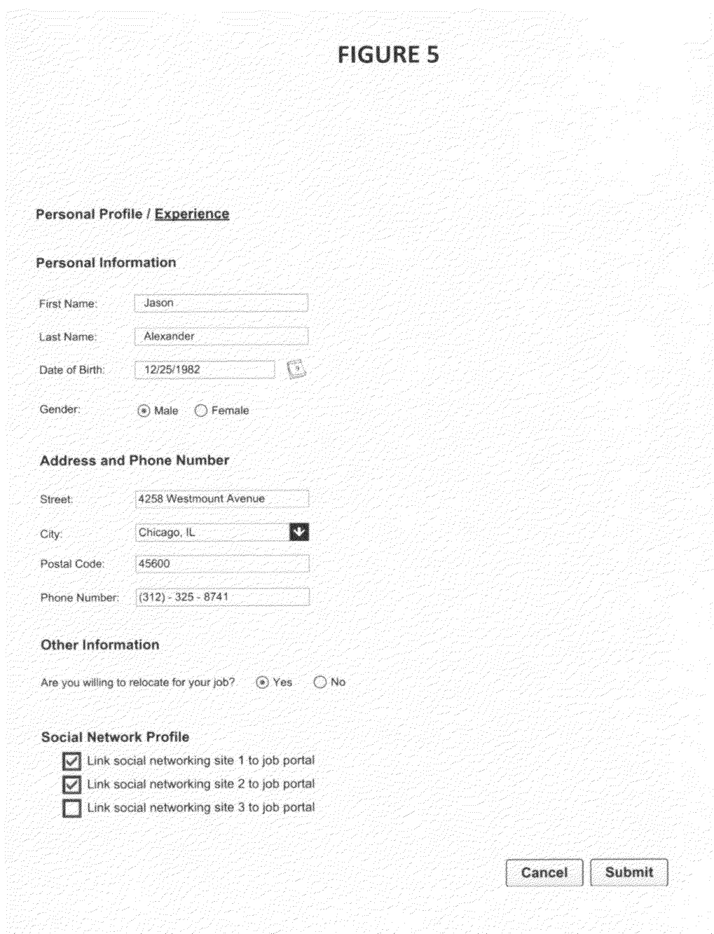

FIG. 3, FIG. 4 and FIG. 5 describe the job seeker section. After registration with the portal the job seeker lands on the job seeker section of the portal. An initial landing page within job seeker section of the portal, as given by FIG. 5, which may be labeled “My Profile” or its equivalent at a navigation menu, allows the job seeker to fill in personal information such as name, date of birth, last salary, sex, address and relocation options. The section may further provide an option to link the job seeker profile with one or more social network. This may become useful if the job seeker wants to find out if any of his or her contacts works for a particular job provider where the job seeker has an interest. As shown in FIG. 4, the section may further provide section wise or continuous information submission and display options of “Job Experience” or its equivalent, “Education” or its equivalent, “Other Skills/Experiences” or its equivalent, “Languages and Other Interests” or its equivalent and submission of resume files that may also be parsed as well as edited. The section may further provide a profile completion indicator window which displays the profile completion percentage. The section may further provide a link, not shown, for social networking option, given by FIG. 5 which may add the portal as friend on social networking sites such as, but not limited to, Facebook and Linkedin. The social networking option may alternatively connect the profile to the job portal social networking application or database which may contain contacts added from job seeker's account on social networking sites such as, but not limited to, Facebook and Linkedin. This addition of contacts to job portal social networking application or database may be effected by sending of invitations directly from job seeker's account on social networking sites or through a widget on the job portal social networking application that goes through the job seeker's account on social networking sites.

Another page of the “Job Seeker” section, given by FIG. 3, allows the job seeker to search for jobs by criteria such as keywords, location and categories. The results to be displayed for the job search may be limited by different options.

Once the job search results are available the job seeker can select potential jobs from the search results and then apply to these positions via a link (not shown). Once a job is selected it is moved to a “Job History” area that may show all the jobs applied for by the job seeker. It is not necessary that all selected jobs are applied to as well. Once the jobs are selected, the job seeker can go to the “Job History” area and go over each of the selected jobs. For each selected job, there is check off list with a ‘yes” or “no”. The check off list comprises of, “Employer Chat”, “Job Analytics” and an optional “Match me with Friends” that is not shown in the figure. If the job seeker checks off a “yes” for “Employer Chat”, then the job seeker may need to download an chat client that can be installed on computer or a wireless mobile phone. The chat client enables the employer to chat with a job seeker without the job seeker logged on to the portal website.

When a job seeker selects a job, the selected employer is added to a list of applied for jobs in a box “Job History” as shown in FIG. 3. The box contains information about the jobs applied for, the date applied on, as well as a geometrical (circular shown) shape area which may give an indication whether the employer has viewed the application or not. If the employer has viewed it, the circular shape may give an indication by a variety of display options. Further, if the employer is viewing the job seeker's application in real time then a different indicator related to the geometrical shape may give that information.

### Job Provider Section

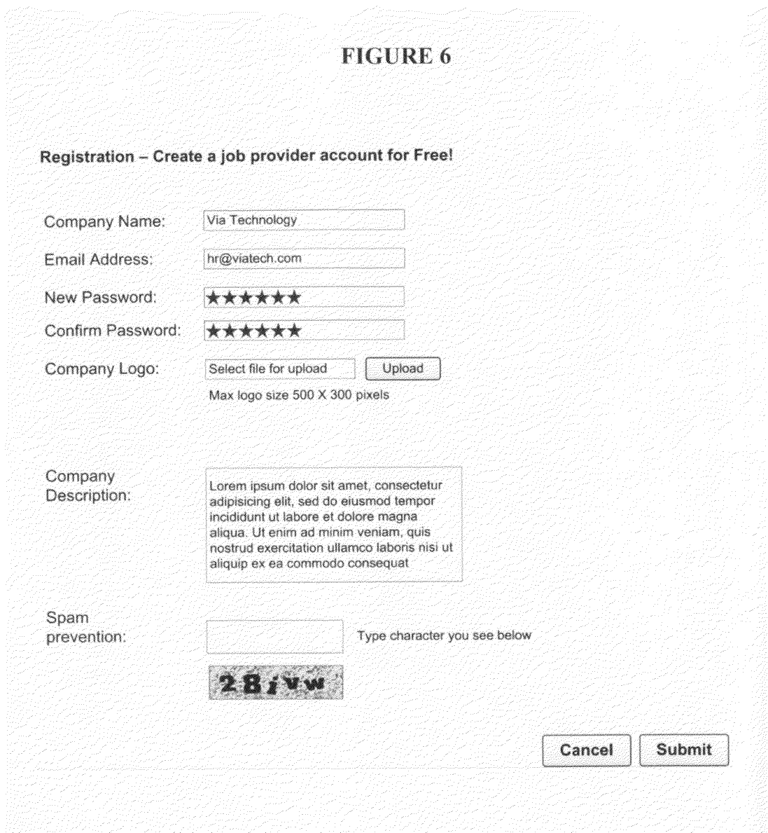

Once a job provider has registered or logged in from the home page, he is prompted to a page “Edit my account” given by FIG. 6. Here the job provider registers in detail, such as the company name, change of email address, confirm password and inserting a company logo. In addition, the job provider can add a company description in a text box. The page may have an anti-spam feature, preventing SPAM by having the job provider type in some characters into a small text box. All this information is saved in a job provider database by clicking a submit button.

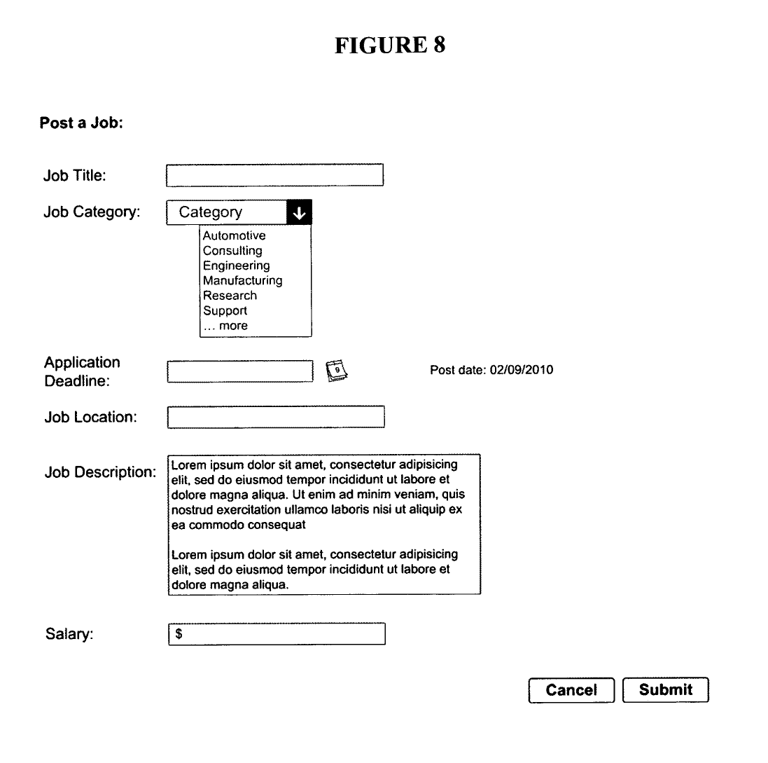

The job provider section also has a job posting page, as shown by FIG. 8, labeled “Post a Job” where a job provider can post a job. The page may be accessed by a link given in a navigation menu. The job posting page may need submission of information under the fields such as “Title”, “Job Category”, ‘Application Deadline”, “Description” and “Salary”. The posting date can be automatically a default when the page is accessed. The job description can then be entered in an open text box. Clicking a submit button at the bottom of the page saves the job record. The job provider may have the option of exiting the page without saving the information as well.

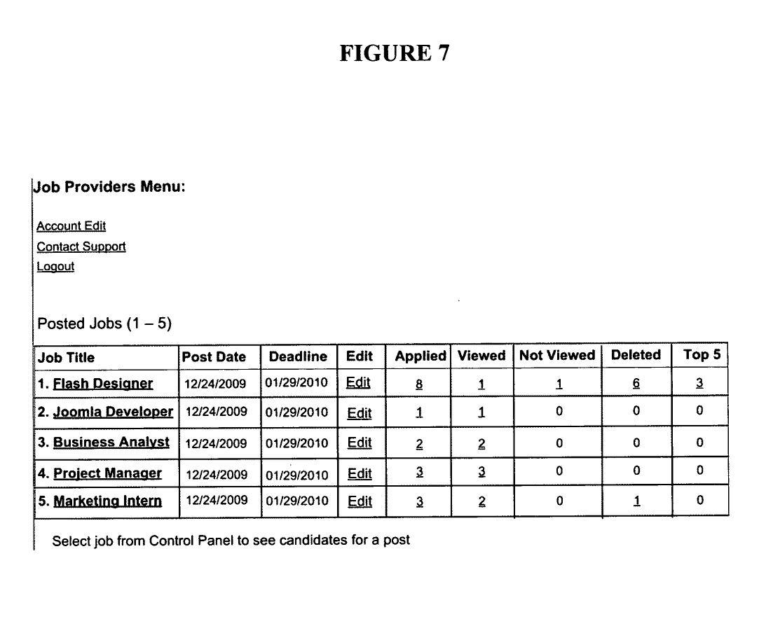

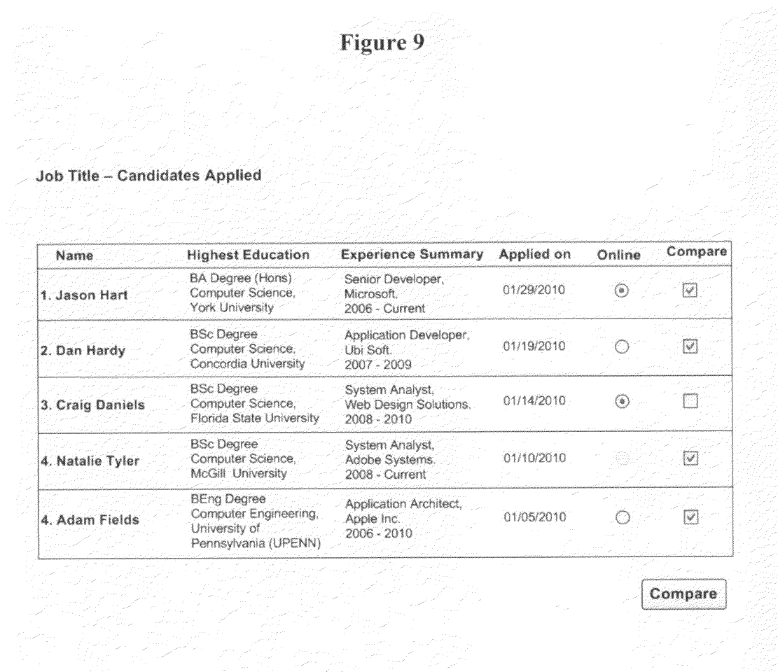

FIG. 7 and FIG. 9, may describe the detailed aspects of the job provider section. The “Provider's Menu” box may have a link for a page from where the job provider can manage all the job applicants who have applied to the jobs posted by the job provider. One box in the page gives the jobs posted by the job provider as given in FIG. 7. The list is given a serial enumeration followed by the “Job title”, “Post date”, “Deadline”, “Edit”, “Applied”, “Viewed”, “Not Viewed”, “Deleted” and “Top 5”. The “Edit” label refers to a function where the job provider may change the job description slightly without changing the core description too much. This may come handy if the job provider is not satisfied with the quality of job applicants. The “Applied” label refers to the number of applicants who have applied for a posted job. The label “Viewed” refers to the applicants for a job reviewed by the job provider whereas the label “Not Viewed” refers to the applicants for a job not reviewed by the job provider. The label “Deleted” refers to applicants deleted by the job provider. Lastly “Top 5” refers to the top five matches that the portal provides to the job provider from all the job applicants who applied for the posted job.

A second box labeled “Candidates Applied” given by FIG. 9 gives a list of the applicants for a job posted by the job provider. The list appears when the job provider selects a job form the first box for posted jobs. The list may also summarize the applicant info such as name, highest degree, experience summary, the date job was applied for. The list may also have two additional columns for labels “Online” and “Compare”. The “Compare” column may have check boxes in each row for each applicant. If the job provider wishes to compare two applicants for the job the portal would compare the full applicant information for each checked applicant against the posted job description and suggest a better candidate. The “Online” label refers to an indicator of online presence to of a particular candidate. The online presence may be due to a login activity at the portal or it may indicate the fact that candidate is online. It may be a reason that the job provider sends a chat message to the online job seeker even without the job seeker being a partial fit for the job. The “Online” label indicator may work by changing a default colour to another differentiating colour which can catch the attention of the job provider. There may be other ways of indicating the seeker's online presence.

In the second box when a job provider select one applicant by clicking the applicant's name, the job provider may be presented with a page labeled “Candidate Details” not shown. The page may give the information about the candidate which the candidate has submitted to the portal as resume information. After reviewing the details the job provider may delete the candidate by pressing a delete function at the bottom of the page.

### Chat Function

Once the job provider determines that a candidate is suitable for a posted or may need further investigation, the job provider looks for the chat enablement of the job seeker and after confirmation of enablement, sends a chat message to the job seeker. The job seeker having already enabled chat feature is likely to be conscious of an incoming message. The expectation is further pushed up if the job seeker observes that the geometrical area in the job seeker section indicates by a display method that that his or her profile has been reviewed. The job seeker observing the incoming message then engages in a chat session with the job provider. The job seeker may not be on the portal or connected to the interne at all, may respond with a chat client installed on a mobile phone. The chat client ensures that a message is received as long as the phone is not shut off The chat session may also take place between two mobile devices of the job seeker and the job provider. For a dual mobile session to take place the job provider must be logged on to the portal website.

Additionally, if the job seeker is not able to respond to the chat request, then optionally the job seeker can pre-record an anticipated text, audio or video response that can be sent to the job provider if the contact is not made at the time of chat request. The pre-recorded response may be stored at the portal website. The job portal senses via a signal that a chat request has been sent to the applicant and if it does not receives a corresponding signal that it has been responded to then it automatically sends the pre-recorded response to the job provider. The whole idea is to come up with a response only when the job provider has reasonably determined his or her interest in the job seeker.

### Portal Admin Control Section

The Portal Admin Control Section, not shown, refers to the various tasks performed by the portal administration. One of the task is performed is that of matching “Top 5” candidates that have applied for a posted job. Admin Control will alert a cognitive agent when a portal posted job has received more than 5 applications from portal registered job seekers. If a posted job receives more than 5 applications then the portal will create Top 5 matches by using Portal matching algorithm and rank and verify its authenticity. Here the ranking and verification can be performed manually or in an automated manner. The cognitive agent may lift information from the text based jobs descriptions (read only) as presented by job provider and populate the appropriate fields in the matching template and run the matching algorithm against all the applicants who has applied for this job as listed in the application received tab in the job provider's section and yield Top 5 matches. Once the Top 5 matches are established the cognitive agent will double confirm this result by reading resumes (read only) of the Top 5 candidates and compare it with the actual job description (read only) to establish the authenticity of the Top 5 matches. In another aspect of the same invention, the “Top 5” candidates may be any number selectable candidates and may be subjected additional screening from an expanded set of filters (not shown) available to the job provider.

Another function of the Admin Control is to validate employer job posting by the cognitive agent. This step is to ensure removal of spam job posts and allowing legitimate job posts to go live. Admin Control will alert the cognitive agent when a new Job is uploaded by a job provider. A cognitive agent will view the job post (read only) and determine based upon a criteria if this is a spam, legitimate or uncertain. If the job is determined to be spam the job posting is deleted as well as flag the job provider as a potential spammer and to be reviewed by supervisor who will decide if this employer/spammer should be banned from the portal. If the job posting is determined to be legitimate than it is allowed to be posted on the portal. If the result is determined to be uncertain, then a supervisor decides about the case.

### Feedback

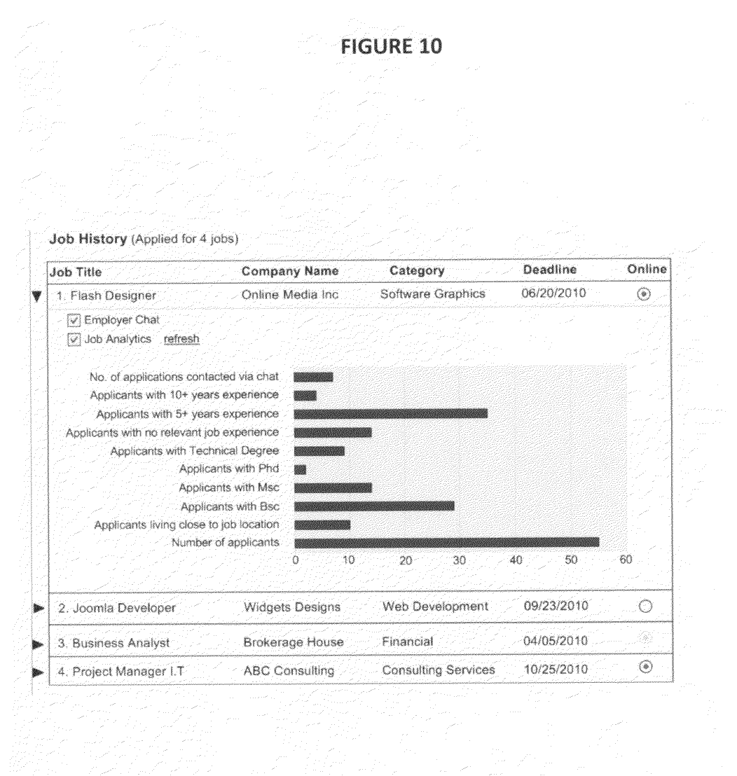

In another aspect of the same invention, the employment portal may provide feedback to seekers on a pre-determined schedule as to the relevancy of with information related to his or her application to a specific job post. This feedback may comprise an explanation about why the seeker has not been contacted by an employer (provider) or why no chat was ever initiated between the provider and the seeker and how the seekers can improve his or her job search. The feedback may further comprise of statistics about general applicant data about a job as shown by FIG. 10. The general applicant data may comprise of number of applicants contacted by the employer, applicants with certain years of experience, applicant with no relevant experience, applicants with various educational or technical degrees such as Ph.D., Masters, Bachelors, MEE, MBA etc., aggregate geographic information about applicants and total number of applicants. Availability of such information potentially increases chance of success in a job hunt. The feedback information may be available as soon as the candidate applies for a job. A pre-job application information may also be available at a fee. Once a job is applied for, the feedback may be updated at selectable intervals or when the job is filled. Optionally, the pre job application feedback may be different from a post-job application feedback and both feedbacks can be made available.

The feedback can affect the job search of an applicant. For instance, the job applicant can increase his or her chance of getting a contact from a job provider by using the information to close gaps in the applicant profile. This may comprise of taking courses in a particular subject needed for a particular art. In another aspect of this invention the data feedback may be monetized.

In a further aspect of this invention the job related statistics feedback is approved by job provider.

It will be appreciated by those skilled in the art that the invention can take many forms, and that such forms are within the scope of the invention as claimed. Therefore, the spirit and scope of the appended claims should not be limited to the descriptions of the preferred versions contained herein.

What is claimed is:

1. A computer implemented method for enabling real time interaction for recruitment between a job seeker and a job provider via an internet based employment portal, the method comprising:
said job provider posting a job on a employment portal server;
said job seeker applying for a posted job on the employment portal server and enabling a chat functionality by checking a check box and downloading a chat client;
said job seeker further checking a check box to access a feedback of job related statistics;
said job seeker being provided with the feedback of job related statistics for the posted job;
the job provider sending a request for a chat session with the job seeker; and
the job provider interacting real time with the job seeker with a downloaded chat client.

2. The method of claim 1 wherein the job provider and the job seeker are both registered with the employment portal.

3. The method of claim 1 wherein the real time interacting job provider is logged in with the employment portal.

4. The method of claim 1 wherein the real time interacting job seeker is not logged in with the employment portal.

5. The method of claim 1 wherein the real time interacting job seeker is interacting using a mobile device.

6. The method of claim 1 wherein the job seeker is informed that the application has been reviewed.

7. The method of claim 1 wherein the job provider is a recruiter.

8. The method of claim 1 wherein the feedback statistics are updated and sent to the job seeker on a regular frequency.

9. The method of claim 1 wherein any feedback statistics are available for a fee.

10. The method of claim 1 wherein the feedback statistics for a posted job are available to a job seeker before applying for the posted job.

11. The method of claim 10 wherein the feedback statistics are available for a fee.

12. The method of claim 10 wherein the feedback statistics for a posted job available to a job seeker before applying for the posted job are different than the feedback statistics available after applying for a job.

13. The method of claim 1 wherein the employment portal authenticates the job provider and the job posted.

14. The method of claim 1 wherein the employment portal server sends a pre-recorded response of the job seeker to the job provider when the employment portal server does not receives a corresponding signal that a chat session request from the job provider has been responded to by the job seeker.

15. The method of claim 14 wherein the pre-recorded response of the job seeker is sent from a mobile device of the job seeker.

16. A system for enabling real time interaction for recruitment between a job seeker and a job provider via an internet based employment portal, via a computer network, comprising:
a first data receiving component, adapted to receive computer readable data, representing information pertaining to a job, is provided by a job provider via said computer network;
the data receiving component, adapted to receive computer readable data, representing information pertaining to a job seeker is provided by the job seeker via said computer network, the information in part comprised of an enabled chat functionality a first checked off check box as well as a second checked off check box to enable job seeker access to a feedback of job related statistics;
a chat client downloaded by the job seeker to a computer as well as a mobile device;
the data receiving component, adapted to receive computer readable data, representing information pertaining to a request from the job provider for a chat session with the job seeker; and
an activated chat client at a second computing device enabling real time interaction between the job provider and the jobseeker.
